(19) United States
(12) Patent Application Publication
(10) Pub. No.: US 2026/0071994 A1
(43) Pub. Date: Mar. 12, 2026

(54) Systems and Methods with Shutter

(71) Applicant: DH Technologies Development Pte. Ltd., Singapore (SG)

(72) Inventors: Brian D. PETERSON, Brea, CA (US); Yagang LIU, Yorba Linda, CA (US)

(73) Assignee: DH Technologies Development Pte. Ltd., Singapore (SG)

(21) Appl. No.: 19/271,319

(22) Filed: Jul. 16, 2025

Related U.S. Application Data
(60) Provisional application No. 63/672,547, filed on Jul. 17, 2024.

(51) Int. Cl. G01N 27/447

(52) U.S. Cl. CPC G01N 27/44721; G01N 27/44791

(57) ABSTRACT

In one aspect, a system is disclosed, which includes at least one capillary configured for receiving a sample, a first light source for generating a first light, a second light source for generating a second light, an optical element for receiving and directing the first and the second light into the at least one capillary, an absorbance detector, and a shutter positioned between the absorbance detector and the at least one capillary. The shutter is movable between an undeployed position and a deployed position. In the undeployed position, at least a portion of the first light passing through the at least one capillary can be received by the absorbance detector. In the deployed position, the shutter inhibits back reflection of the light exiting the at least one capillary to the at least one capillary.

### RELATED APPLICATIONS

This application claims priority to U.S. Provisional Application No. 63/672,547 filed on Jul. 17, 2024, the contents of which are incorporated herein by reference in their entirety.

### FIELD

The present disclosure generally relates to systems (e.g., capillary electrophoresis systems, including multi-mode and/or multi-capillary systems) and methods. More particularly, certain aspects of the disclosure relate to such systems and methods that allow a reduction in crosstalk (e.g., among a plurality of capillaries) and/or a reduction in noise (e.g., noise associated with fluorescence detection).

### BACKGROUND

Capillary electrophoresis (CE) is a technique often employed for rapid separation and analysis of charged species, such as nucleic acids, amino acids, proteins, viruses, and bacteria. CE instruments with high throughput that allow fast analysis (e.g., analysis of a plurality of samples) are also known (see, e.g., WO2021095006A1, which is hereby incorporated by reference). However, high throughput instruments (e.g., multi-capillary CE instruments) might suffer from crosstalk issues (e.g., when a signal from one capillary is observed in and/or interferes with the data collected for another capillary (e.g., a neighboring capillary)), high noise levels, and other issues associated with detection. Likewise, CE instruments that allow for several modes of detection (e.g., absorbance detection (e.g., UV absorbance detection), laser-induced fluorescence, and/or native fluorescence) might suffer from similar issues. There is a need for improved instruments (e.g., CE instruments, multi-capillary CE instruments, CE instruments that allow for several modes of detection) and methods that exhibit reduced crosstalk (e.g., when the detection is done on a plurality of capillaries) and/or reduced noise.

### SUMMARY

In one aspect, a system is disclosed, which includes at least one capillary configured for receiving a sample, a first light source for generating a first light, a second light source for generating a second light, an optical element for receiving and directing the first and the second light into the at least one capillary, an absorbance detector, and a shutter positioned between the absorbance detector and the at least one capillary, wherein the shutter is movable between an undeployed position and a deployed position, wherein in the undeployed position, at least a portion of the first light passing through the at least one capillary can be received by the absorbance detector, and wherein in the deployed position, the shutter inhibits back reflection of the light exiting the at least one capillary to the at least one capillary.

In various embodiments, the first light source can include a first UV light source. In various embodiments, the second light source can include a second UV light source or a visible light source. By way of example, and without limitation, the second UV light source can include a UV LED or a UV laser and the visible light source can include a visible laser light source.

In various embodiments, the first light source and the second light source can include different UV light sources. By way of example, and without limitation, one of the two different UV light sources can include a broadband UV light source and the other one of the two different UV light sources can include a monochromatic UV light source. Again, by way of example, and without limitation, the broadband UV light source can include a UV lamp and the monochromatic UV light source can include a UV light emitting diode (LED) or a UV laser.

In various embodiments, the system includes a fluorescence detector. The fluorescence detector is configured to detect a fluorescence of the sample generated in response to excitation thereof by the second light. By way of example, and without limitation, the fluorescence detector can include a laser-induced fluorescence (LIF) detector or a native fluorescence detector.

In various embodiments, the first light is configured to be at least partially absorbed by the sample so as to allow measurement of an absorbance of the sample using the absorbance detector and the second light is configured to excite fluorescence of the sample so as to allow measurement of fluorescence emitted by the sample by the fluorescence detector.

In various embodiments, the at least one capillary includes a first capillary and at least one other capillary, and wherein in the deployed position, the shutter inhibits back reflection of a light exiting the first capillary to the at least one other capillary.

In various embodiments, the shutter includes a slanted surface for reflecting at least a portion of the light exiting the at least one capillary into a path different from a path along which the light exiting the at least one capillary propagates to the absorbance detector. In some such embodiments, when in the deployed position, the shutter at least partially blocks the light exiting the at least one capillary from reaching the absorbance detector.

In various embodiments, the system can include an actuating system for transitioning the shutter between the deployed and the undeployed positions. By way of example, and without limitation, the shutter can include a light-blocking arm and a lever arm that is connected to the light-blocking arm. The actuating system can be coupled to the lever arm to actuate the movement of the shutter between the deployed and undeployed positions.

In various embodiments, the optical element is configured to direct the first light and the second light into the at least one capillary along at least one common path.

In various embodiments, the at least one capillary includes a plurality of capillaries and the optical element is configured to scan the first light and/or the second light across said plurality of capillaries.

In various embodiments, the absorbance detector can include a UV lens and the shutter is positioned in front of the UV lens.

In various embodiments, the system can further include at least one controller in communication with the shutter, where the at least one controller is configured to transition the shutter from the undeployed position to the deployed position when the second light source is generating the second light and/or when the second light is employed for performing a native fluorescence measurement or a laser-induced fluorescence (LIF) measurement.

Further, the at least one controller can be configured to control operation of the first and the second light sources, where optionally the at least one controller includes a first controller for controlling the shutter and a second controller for controlling the operation of the first and the second light sources.

In various embodiments, the at least one controller can be further configured, during a setup period, to activate the first light source to generate the first light or the second light source to generate the second light, to cause the optical element to scan the first light or the second light across said at least one capillary, and to cause the light exiting the at least one capillary to be detected so as to determine a position of the at least one capillary, where optionally the position of the at least one capillary is determined relative to a propagation direction of the first light or the second light.

In various embodiments, the at least one controller can include said first controller, said second controller, and a third controller for controlling the optical element for scanning the first light or the second light and a fourth controller for processing the detected light exiting the at least one capillary.

In various embodiments, the at least one controller can cause the light exiting the at least one capillary to be detected with the absorbance detector so as to determine the position of the at least one capillary.

In various embodiments, the at least one controller can cause the shutter to be in the undeployed position during the setup period.

In various embodiments, the at least one capillary can include a plurality of capillaries and the at least one controller is configured to scan the first light or the second light across the plurality of capillaries in an interlacing pattern.

In various embodiments, the system can further include a focusing lens that is positioned between the first light source and/or the second light source and the least one capillary for focusing any of the first light and/or the second light into the at least one capillary. In some such embodiments, the focusing lens is movable to accommodate a change in a focal length thereof based on a change in the wavelength of the first light and/or the second light. By way of example, and without limitation, a lens scanning mechanism can be coupled to the focusing lens and can be operating under the control of the controller for moving the focusing lens.

In a related aspect, a method is disclosed, which includes introducing a first light or a second light into at least one capillary configured to receive a sample, using an absorbance detector to detect at least a portion of a light exiting the at least one capillary, subsequently, moving a shutter positioned between the at least one capillary and the absorbance detector into a deployed position in which the shutter inhibits back reflection of the light exiting the at least one capillary to the at least one capillary, and performing a fluorescence measurement while the shutter is in the deployed position.

In various embodiments, when in the deployed position, the shutter at least partially blocks the light exiting the capillary from reaching the absorbance detector.

In various embodiments, the fluorescence measurement can include a laser induced fluorescence measurement or a native fluorescence measurement.

In various embodiments, the at least one capillary can include a plurality of capillaries. In various embodiments, a position of the one or more capillaries can be determined by scanning the first light or the second light across the one or more capillaries and detecting the light exiting the one or more capillaries to determine a position of the one or more capillaries. By way of example, and without limitation, the position of the one or more capillaries can be determined relative to a propagation direction of the first or the second light.

In various embodiments, an optical element can be used to scan the first or the second light across the capillaries, e.g., for determining the positions of the capillaries and/or the performance of the absorbance and/or fluorescence measurements.

In various embodiments, the performance of the fluorescence measurement includes using one or more optical fibers positioned relative to the at least one capillary for receiving the light exiting the at least one capillary and a fluorescence detector for detecting the light exiting the at least one capillary.

In various embodiments, the step of introducing the first light or the second light into the at least one capillary can include directing the first light and the second light along a common path to the at least one capillary.

In various embodiments, a focusing lens can be used to focus the first and/or the second light (e.g., a light generated by a first UV light source, a second UV light source, and/or a visible light source) into the at least one capillary. In some such embodiments, a position of the focusing lens can be adjusted relative to that of the at least one capillary to accommodate a change in a focal length thereof based on a change in the wavelength of the first light and/or the second light.

In a related aspect, a method is disclosed, which includes transitioning a shutter, positioned between an absorbance detector and at least one capillary in a multi-mode capillary electrophoresis system, between an undeployed position and a deployed position, wherein in the undeployed position the absorbance detector can receive at least a portion of the first light passing through said at least one capillary, wherein in the deployed position the shutter inhibits back reflection of the light exiting the at least one capillary to the at least one capillary, thereby reducing at least one of a cross talk and a fluorescence light detection noise in the at least one capillary, and wherein the multi-mode capillary electrophoresis system comprises a first light source for generating the first light, a second light source for generating a second light and an optical element for scanning the first light and/or the second light across the at least one capillary. The absorbance detector can receive the at least the portion of said first light passing through said at least one capillary for performing an absorbance measurement. Further, in some embodiments, the absorbance detector can also detect the second light for determining the positions of the one or more capillaries (e.g., relative to the propagation direction of the second light).

In various embodiments, in the deployed position, the shutter at least partially blocks the light exiting the at least one capillary from reaching the absorbance detector.

In various embodiments, the method can further include scanning the first light or the second light across the at least one capillary while the shutter is in the undeployed position and detecting the light exiting the at least one capillary to determine a position of the at least one capillary. By way of example, and without limitation, the position of the at least one capillary can be determined relative to a propagation direction of the first or the second light.

In various embodiments, the first light or the second light can be scanned across the at least one capillary while the shutter is in the deployed position to elicit a laser induced fluorescence or a native fluorescence from at least one sample in the at least one capillary. In some such embodiments, the at least one capillary can include a plurality of capillaries and the first or the second light can be scanned across those capillaries, e.g., for performance of an absorbance and/or a fluorescence measurement.

In various embodiments, the step of scanning the first light or the second light across the at least one capillary includes directing the first light or the second light into each of said at least one capillary along a common path.

In various embodiments, a focusing lens can be utilized to focus the first light or the second light into each of the one or more capillaries.

In various embodiments, the method further includes adjusting a position of the focusing lens to accommodate a change in a focal length thereof based on a change in wavelength of the first and/or the second light.

In various embodiments, a fluorescence detector can be employed to detect the laser induced fluorescence or the native fluorescence and to generate one or more fluorescent signals.

In various embodiments, the shutter's deployed position results in a reduction of noise associated with the one or more fluorescent signals.

In various embodiments, the at least one capillary includes a plurality of capillaries.

Further understanding of various aspects of the present teachings can be obtained with reference to the following detailed description in conjunction with the associated drawings, which are described briefly below.

### BRIEF DESCRIPTION OF THE DRAWINGS

FIG. 1A is a perspective schematic view of a multi-mode electrophoresis system according to an embodiment of the present teachings,

FIG. 1B is a perspective schematic view of a rotatable mount to which two filters are mounted, where the mount can be rotated to place one of the two filters in the path of UV light emitted from a UV light source in the multi-mode electrophoresis system, according to an embodiment,

FIG. 1C is a partial schematic perspective view of the electrophoresis system depicted in FIGS. 1A and 1B, according to an embodiment,

FIG. 1D is another partial schematic perspective view of the electrophoresis system depicted in FIGS. 1A and 1B, according to an embodiment,

FIG. 1E is a partial schematic view of the electrophoresis system, illustrating a fluorescence detector of the system and a plurality of optical fibers that transmit fluorescence light emitted by samples in a plurality of capillaries, according to an embodiment,

FIG. 1F schematically depicts the reflection of a light ray from a slanted surface of a shutter. positioned between at least one capillary and a detector (e.g., an absorbance detector, which might include a UV lens) in an electrophoresis system according to an embodiment,

FIG. 2A schematically depicts a cartridge including a plurality of capillaries and mounted to a holder in an electrophoresis system according to an embodiment for positioning the capillaries in a path of a light emitted by a light source,

FIGS. 2B and 2C schematically depict a plurality of capillaries employed in an embodiment of the present teachings, where the capillaries are bonded to a chip,

FIG. 3 shows a plurality of optical fibers for directing fluorescence generated by samples in the capillaries to a fluorescence detector,

FIG. 4A schematically depicts a detector (e.g., an absorbance detector) of an electrophoresis system with a shutter in a deployed position, according to an embodiment,

FIG. 4B schematically depicts the shutter shown in FIG. 4A in an undeployed position, according to an embodiment,

FIG. 4C schematically depicts a cross-section of a mount in a mechanism for moving the shutter between a deployed and an undeployed position,

FIG. 5 is a schematic perspective view of a lens positioning mechanism and a focusing lens coupled to the lens positioning mechanism in an embodiment of an electrophoresis system, and

FIG. 6 schematically depicts an example of an implementation of a controller according to an embodiment.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also, for brevity, not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or less than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”. Although some aspects have been described in the context of an apparatus, it is clear that these aspects also represent a description of the corresponding method, where a block or device corresponds to a method step or a feature of a method step. Analogously, aspects described in the context of a method step also represent description of a corresponding block or item or feature of a corresponding apparatus. Some or all of the method steps may be executed by (or using) a hardware apparatus, like for example, a processor, a microprocessor, a programmable computer or an electronic circuit. In some embodiments, one or more of the most important method steps may be executed by such an apparatus.

The present disclosure generally relates to systems (e.g., capillary electrophoresis systems, including multi-mode and/or multi-capillary systems) and methods. More particularly, certain aspects of the disclosure relate to such systems and methods that allow a reduction in cross-talk (e.g., among a plurality of capillaries) and/or a reduction in noise (e.g., noise associated with fluorescence detection). In some aspects, the present disclosure relates to multi-mode capillary electrophoresis systems and associated methods for analyzing sample(s) in one or more capillaries of the electrophoresis system.

In some CE systems, a plurality of capillaries is utilized to expose samples in the capillaries to light (e.g., UV and/or visible light) to analyze the samples. For example, the UV light can be used to measure UV absorbance, a visible light (e.g., generated by a laser) can be used to perform laser induced fluorescence (LIF) measurement, and/or another UV light can be used to measure native fluorescence of the samples.

In some examples, a detector (e.g., an absorbance detector that detects light passing through at least one capillary for measuring absorbance of the sample in the at least one capillary (e.g., a UV absorbance detector)) can be located along the optical axis of a first light (e.g., a light used for absorbance measurements (e.g., a UV light used for UV absorbance measurement)) and a second light (e.g., a light used for measuring fluorescence, such as a light configured to excite fluorescence in a sample (e.g., a visible laser light used for LIF measurements or another UV light used for native fluorescence measurements). In some examples, an absorbance detector (e.g., a UV absorbance detector) can be located along the optical axis of the UV light used to measure UV absorbance and a laser light used to measure LIF of the samples. In some examples, when scanning the capillaries with a laser light to perform LIF measurements, at least a portion of the light exiting the capillaries may be reflected back from an absorbance detector (e.g., from a UV lens of an absorbance detector) toward the capillaries. In some examples, an absorbance detector (e.g., a UV absorbance detector) can be located along the optical axis of the UV light used to measure UV absorbance and another UV light used for measuring native fluorescence of the samples (e.g., via a fluorescence detector (e.g., a photomultiplier tube)). When scanning the capillaries with another UV light to perform native fluorescence measurements, at least a portion of the light exiting the capillaries may be reflected back (e.g., from a UV lens of the UV detector) toward the capillaries. As a result, some of the back-reflected light may be incident on capillaries (e.g., on the capillaries other than the capillary under analysis, typically adjacent capillaries), and may lead to detection of fluorescence (e.g., of laser-induced or native fluorescence) from those capillaries. For example, a fluorescent light at a detectable level may emanate from capillaries adjacent to a capillary under analysis through which a high concentration of an analyte of interest flows. This might create an anomaly typically referred to as crosstalk, where, e.g., a signal from one capillary is observed in and/or interferes with the data collected for another capillary (e.g., a neighboring capillary). For example, fluorescence light detected on a sample in a particular capillary might be attributable to another sample flowing through the adjacent capillary. Even in the absence of such crosstalk, during a fluorescence measurement (e.g., an LIF or native fluorescence measurement), the light exiting a capillary may be back reflected (e.g., to the same or other capillary), leading to an increase in the noise associated with the measurement.

In various embodiments, the system can operate in an absorbance mode (e.g., a UV absorbance mode) and a fluorescence mode (e.g., a native fluorescence mode or an LIF mode). In some embodiments, the system can operate in at least two of the following operational modes: (1) a UV absorbance mode, (2) a native fluorescence mode (e.g., where native fluorescence is induced by a UV light), and (3) a laser induced fluorescence (LIF) mode (e.g., where an LIF is induced by a visible laser light). In some embodiments discussed below, the system can operate in any of these three operational modes.

In some embodiments, the first light is configured to be at least partially absorbed by the sample so as to measure an absorbance of the sample using the absorbance detector. In some embodiments, in the absorbance mode, the sample(s) in one or more of the capillaries (e.g., flowing through one or more capillaries) are illuminated with a first light and at least a portion of the first light passing through the capillaries is detected via an absorbance detector (which, e.g., generates detection signals in response to at least a portion of the first light passing through the capillaries). In some embodiments, the first light is a first UV light. In some embodiments, the first light source comprises a first UV light source. In some embodiments, in the UV absorbance mode, the sample(s) in one or more of the capillaries (e.g., flowing through one or more capillaries) are illuminated with a UV light (e.g., generated by the first UV light source) and at least a portion of the UV light passing through the capillaries is detected via a UV absorbance detector (which, e.g., generates detection signals in response to at least a portion of the first light passing through the capillaries). In some embodiments, the detection signals can be processed to determine the absorbance of the sample(s) at the wavelength of the UV light used for illumination.

In some embodiments, the second light is configured to excite fluorescence of the sample. In some embodiments, in the fluorescence mode, a second light is employed to excite one or more fluorophores of one or more compounds present in the sample(s) in the capillaries (e.g., flowing through the capillaries). In some embodiments, a system comprises at least one capillary configured for receiving a sample (for example, two or more samples may be received by the same capillary (e.g., sequentially) or two or more different capillaries). In some embodiments, the first light might be configured to be at least partially absorbed by a first sample of the two or more samples (e.g., to allow measurement of an absorbance of the first sample using the absorbance detector). In some embodiments, the second light is configured to excite fluorescence of a second sample of the two or more samples (e.g., to allow measurement of fluorescence of the second sample). In some embodiments, the second light is a second UV light (e.g., a UV light emitting diode or a UV laser) or a visible light (e.g., a laser light). In some embodiments, the second light source comprises a second UV light source (e.g., comprising a UV light emitting diode or a UV laser) or a visible light source (e.g., a laser light source). In some embodiments, the first light source and the second light source comprise two different UV light sources. In some embodiments, the first light source comprises the first UV light source and the second light source comprises the second UV light source. In some embodiments, the first UV light source and the second UV light source are different. In some embodiments, in the native fluorescence mode, a second light (e.g., a second UV light) is employed to excite one or more native fluorophores of one or more compounds present in the sample(s) in the capillaries (e.g., flowing through the capillaries). Native fluorescence is a fluorescence that is intrinsic to a compound; such fluorescence can be detected (e.g., using fluorescence spectroscopy) without having to add (e.g., modify compound with) fluorescent dyes, markers, or tags to the compound. Native fluorescence can be detected via a fluorescence detector; that can be analyzed. In some embodiments, in the LIF mode, a laser light (e.g., a visible light) generated is used to excite one or more samples in the capillaries (e.g., flowing through the capillaries). In some embodiments, compounds (e.g., compounds in a sample) may be modified to add a fluorophore (e.g., with fluorescent dyes, markers, or tags) and LIF may be then used. In some embodiments, the resultant fluorescent light is detected by the fluorescence detector and the detection signals are generated by the fluorescence detector; the signals can then be analyzed.

In some embodiments, a system comprises a first light source for generating a first light (which, e.g., can be used for an absorbance mode) and a second light source (which, e.g., can be used for a fluorescence mode). In some embodiments, a system comprises a UV light source for generating a UV light (which, e.g., can be used for UV absorbance mode), a visible light source (e.g., a laser source) for generating a visible light (which, e.g., can be used for the LIF mode), and/or another UV light source for generating another UV light (which, e.g., can be used for native fluorescence). In some embodiments, a system comprises a UV light source for generating a UV light (which, e.g., can be used for UV absorbance mode) and a visible light source (e.g., a laser light source) for generating a visible light (which, e.g., can be used for the LIF mode). In some embodiments, a system comprises a UV light source for generating a UV light (which, e.g., can be used for UV absorbance mode) and another UV light source for generating another UV light (which, e.g., can be used for native fluorescence).

In various embodiments, during a setup period (e.g., a separate setup period for each of the operational modes of the system), the position of at least one capillary (e.g., positions of a plurality of capillaries) are determined. In some embodiments, the position may be determined relative to a propagation direction of the first or the second light. In some embodiments, the first (or the second light) can be scanned across the capillaries and the light exiting the capillaries can be detected to determine the positions of the capillaries. In some embodiments, an absorbance detector can be used for determining the position of the at least one capillary; in some embodiments, the absorbance detector is used when the first and/or second light are used for scanning across the capillaries. In some embodiments, a UV light can be scanned across the capillaries and the light exiting the capillaries can be detected. In some embodiments, a UV absorbance detector can be used for the detection. In some embodiments, an absorbance detector (e.g., a UV absorbance detector) can be used for determining the position of at least one capillary (e.g., during a setup period) and for measuring absorbance (e.g., in an absorbance mode). The determination of the position of the at least one capillary (and typically a plurality of capillaries) can be made using an absorbance detector (e.g., a UV absorbance detector) and any of the light sources employed in a system according to the present teachings. For example, in various embodiments, the absorbance detector can detect not only UV light but also visible light. Thus, in such embodiments, the determination of the position of the at least one capillary can be performed using both the UV as well as the visible light.

In some embodiments, a visible light (or another UV light) can be scanned across the capillaries and the light exiting the capillaries can be detected. In some embodiments, a fluorescence detector can be used for the detection. In some embodiments, an absorbance detector can be used for the detection (e.g., when a visible light or another UV light are used for scanning across the capillaries). In some embodiments, light detection signals can be generated. In some embodiments, the light detection signals can in turn be processed to determine the position of each capillary. For example, each peak in the light detection signals can indicate the position of a window associated with one of the capillaries through which the first (e.g., UV) or the second (e.g., another UV or visible) light can be introduced into the at least one capillary.

In various embodiments, a shutter inhibits back reflection of the light exiting the at least one capillary to the at least one capillary (e.g., by absorbing and/or reflecting the light exiting the at least one capillary). In some embodiments, the shutter positioned between the at least one capillary and the absorbance detector (e.g., a UV absorbance detector) is employed to reflect the light exiting the at least one capillary along a direction that would inhibit the back reflection (e.g., via reflection from the absorbance detector (e.g., from a lens of the UV absorbance detector)) of the light exiting the at least one capillary back to the capillaries in order to reduce, minimize (e.g., as compared to when the shutter is not used), or eliminate, cross-talk between capillaries (e.g., in particular between adjacent capillaries). In some embodiments, the use of the shutter can reduce, minimize, or preferably eliminate, crosstalk between different capillaries. In some embodiments, the use of the shutter can reduce noise (e.g., as compared to when the shutter is not used) during detection (e.g., a light detection noise in the at least one capillary). In some embodiments, the shutter inhibits the back reflection of the light exiting the at least one capillary by at least partially absorbing the light exiting the at least one capillary. In some embodiments, the shutter inhibits the light exiting the at least one capillary from being back reflected into the at least one capillary by at least partially reflecting the light exiting the at least one capillary in a direction (e.g., away from the at least one capillary) that is different from a direction associated with a back reflection of the light to the at least one capillary. In some embodiments, the at least one capillary comprises a first capillary and at least one other capillary, and wherein in the deployed position, the shutter at least partially reflects and/or at least partially absorbs a light exiting the first capillary so as to inhibit back reflection thereof to the at least one other capillary. In some embodiments, the shutter inhibits, and preferably eliminates, the back reflection of the light exiting a first capillary into the first capillary and/or a second capillary.

The term “light” is used herein to refer to a radiant energy having any wavelength across the electromagnetic spectrum, including, e.g., in a wavelength range of about 100 nm to about 400 nm (e.g., for UV light) and/or a wavelength range of about 400 nm to about 700 nm (e.g., visible light).

The term “native fluorescence” is used herein to refer to fluorescence emitted by one or more endogenous (intrinsic) fluorophores in a sample in response to excitation of the sample. Such fluorescence is emitted by the fluorophores in a sample without addition of the fluorophore dyes, markers, labels, and/or tags to the sample.

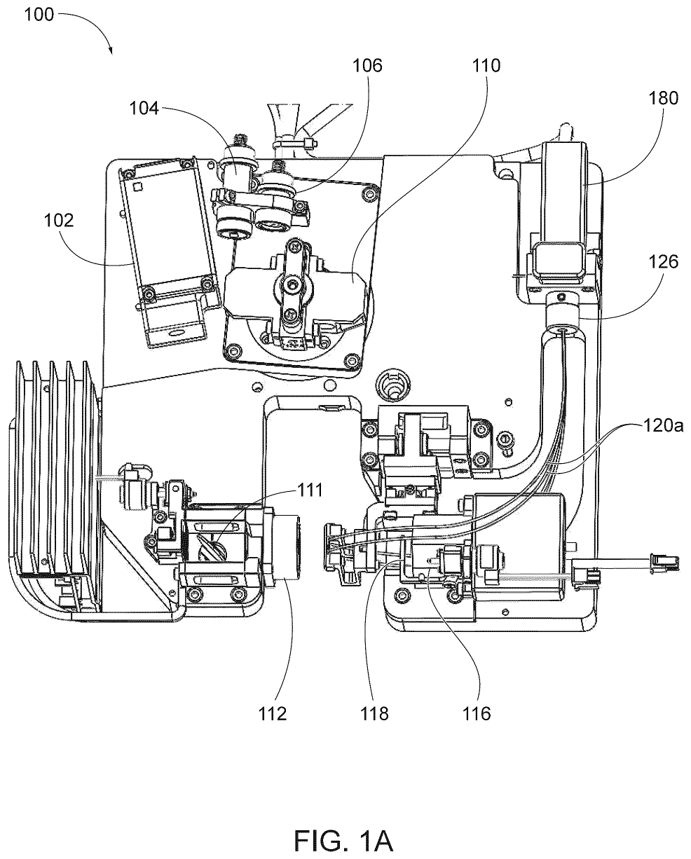

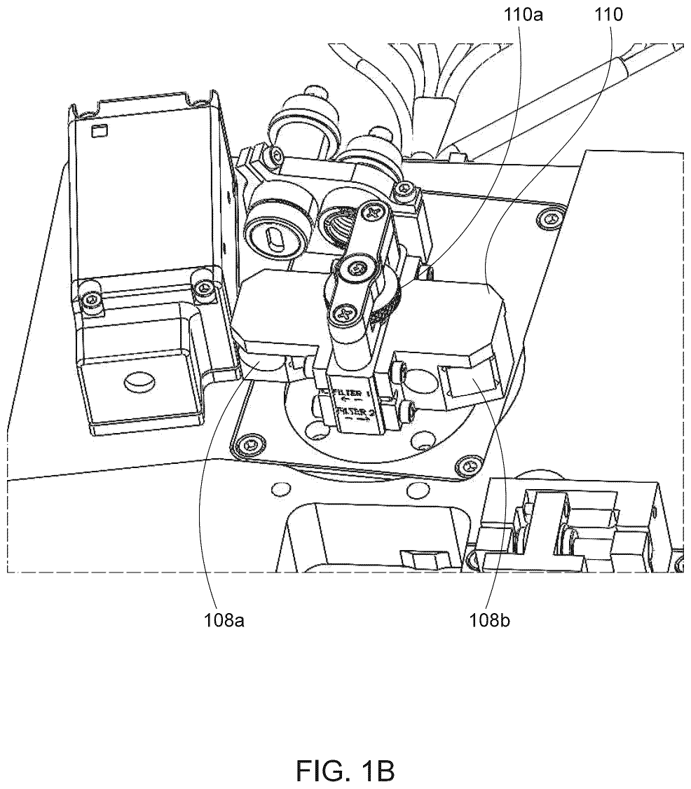

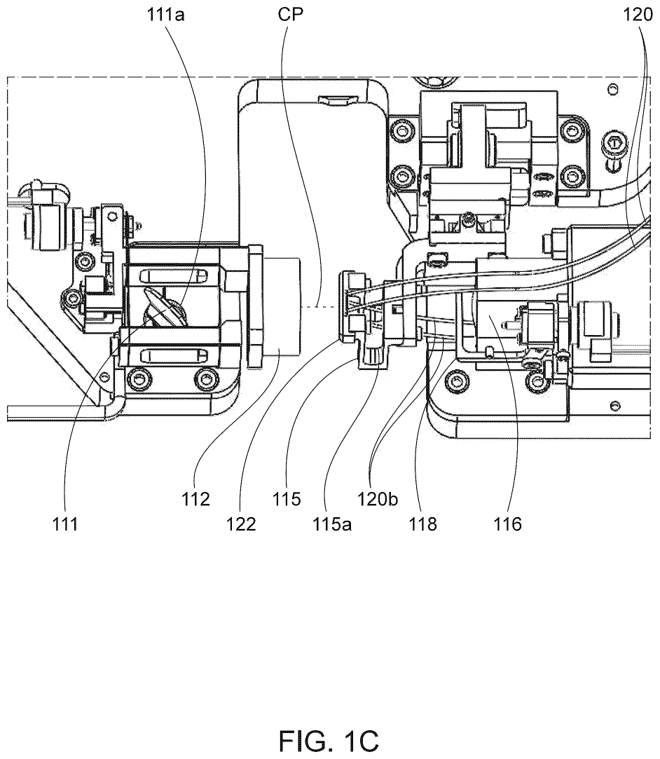

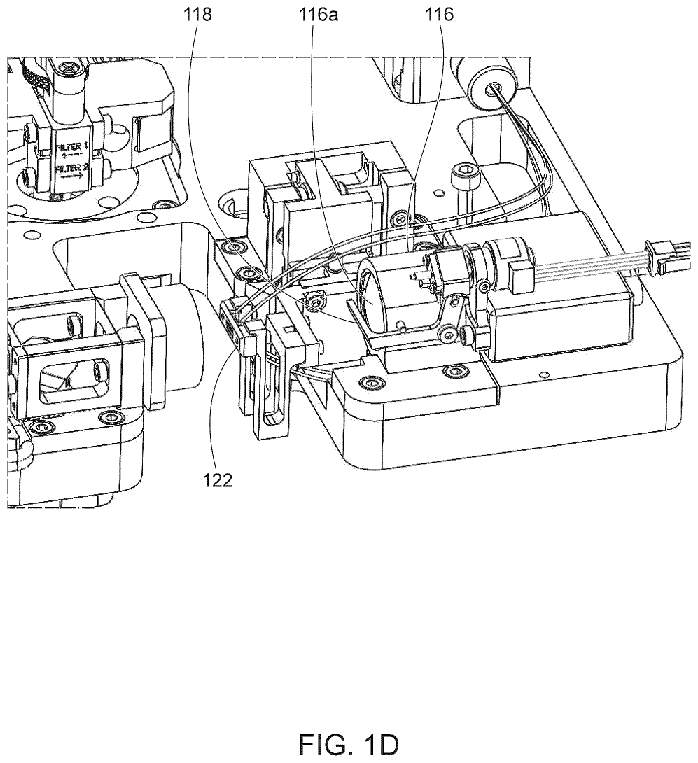

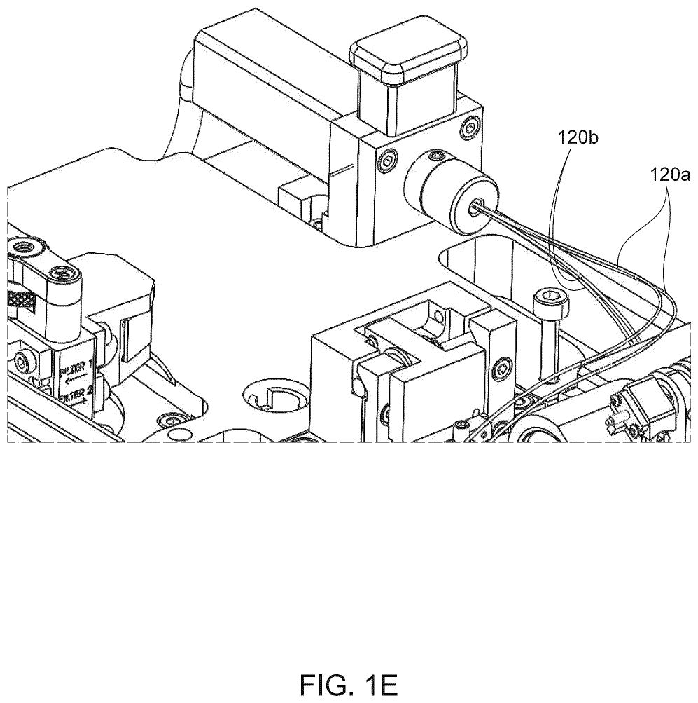

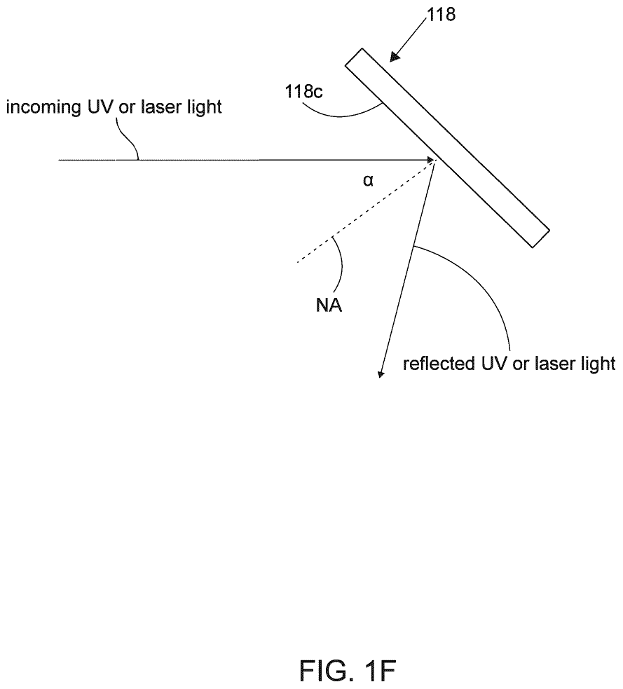

With reference to FIGS. 1A, 1B, 1C, 1D, 1E and 1F, a multi-mode capillary electrophoresis system 100 according to an embodiment includes a laser source 102 that generates laser light, and two UV light sources for generating a UV light (104 and 106). By way of example, the UV light sources may be used for different modes of analysis and/or detection. For example, the UV light source 104 might be used for fluorescence mode (e.g., native fluorescence mode in which native fluorescence emitted by the sample(s) is detected); and the UV light source 106 might be used for absorbance mode (e.g., UV absorbance mode in which absorbance of UV light by the sample(s) is detected). In some embodiments, the UV light source may generate a UV light with a broad spectrum (e.g., multispectral light)—e.g., in some embodiments the UV light source may comprise a broadband UV light source. In some embodiments, a light generated by a source may be further filtered before reaching at least one capillary (e.g., a filter might be used to filter out the light with undesired wavelengths, resulting in only the specific wavelength or range of wavelengths of the light passing through the filter). In some embodiments, the UV light generated by the UV light source may be further filtered before reaching the at least one capillary (e.g., a filter might be used to filter out the light with undesired wavelengths, resulting in only the specific wavelength or range of wavelengths of the UV light passing through the filter). In some embodiments, the UV light source may generate a monochromatic UV light (or near monochromatic light, e.g., a light having a narrow range of wavelengths). In some embodiments, the UV light source 104 might generate a monochromatic (or near monochromatic) UV light; in some embodiments, the UV light source 106 might generate a multispectral light. In some embodiments, a light source can include a light emitting diode (LED). In some embodiments, a UV light source (e.g., the UV light source 104) can include a UV LED. In some embodiments, a UV light source can include a collimator that can be employed to collimate the light generated by the UV light source (e.g., a fiber optic may carry a light from an energy source to the collimator which creates a collimated light). In some embodiments, a UV light source can be a UV laser. In some embodiments, the UV light source 104 can generate a monochromatic UV light having a wavelength, e.g., from about 200 nm to about 400 nm. In some embodiments, the UV light source 104 can generate a near monochromatic UV light. In some embodiments, a light source can include a lamp. In some embodiments, a UV light source (e.g., the UV light source 106) can include a UV lamp generating UV light with wavelengths, e.g., in a range of about 200 to about 400 nm. In some embodiments, a light source can include a visible laser. In some embodiments, the laser light source 102 can generate a laser light with a wavelength in the visible range of the electromagnetic spectrum (a visible laser light), e.g., in a range of about 400 nm to about 700 nm.

In some embodiments, two filters 108a/108b (see, FIG. 1B) are mounted on a rotatable mount 110, where the rotation of the mount allows selectively placing a filter (e.g., one of the two filters) in the path of the UV light generated by the UV light source 106 (e.g., which includes a UV lamp) to select the wavelength of interest. By way of example, and without limitation, the wavelength of interest can be any of the following wavelengths: 214 nm, 220 nm, 260 nm, and 280 nm. In some embodiments, the filters 108a/108b can be replaceable with other filters to expand the range of wavelengths that can be employed. In some embodiments, the rotatable mount 110 includes a knob 110a that allows a user to manually exchange the two filters (unscrewing the knob allows the filters to be exchanged or replaced). In some embodiments, the rotatable mount 110 can be automatically rotated, under control of a controller, between its positions (e.g., two positions).

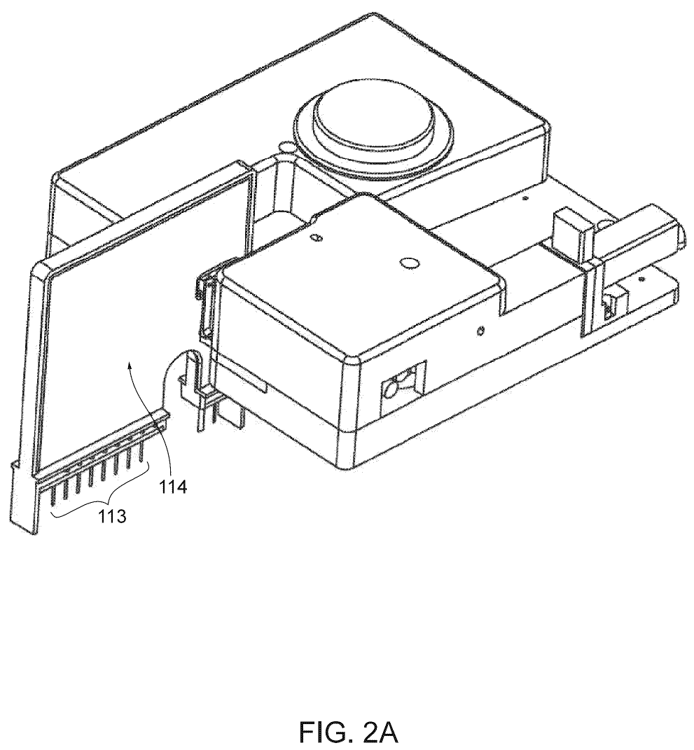

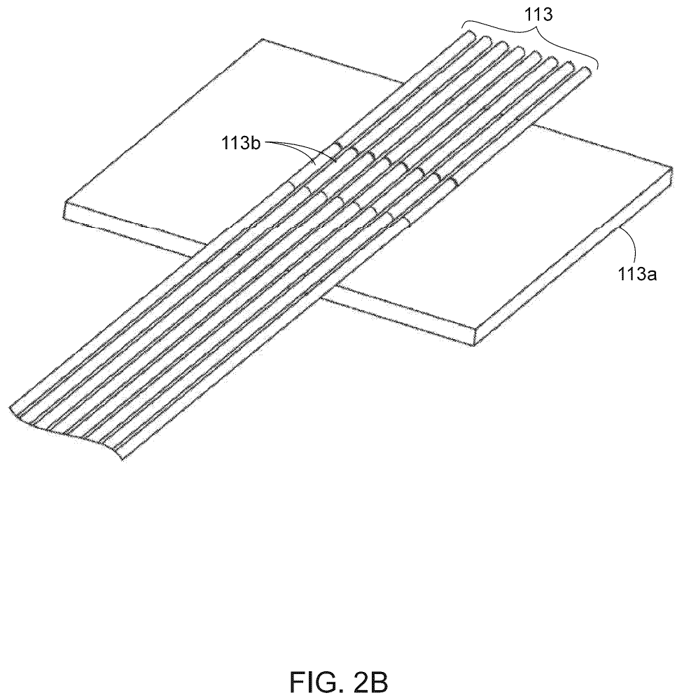

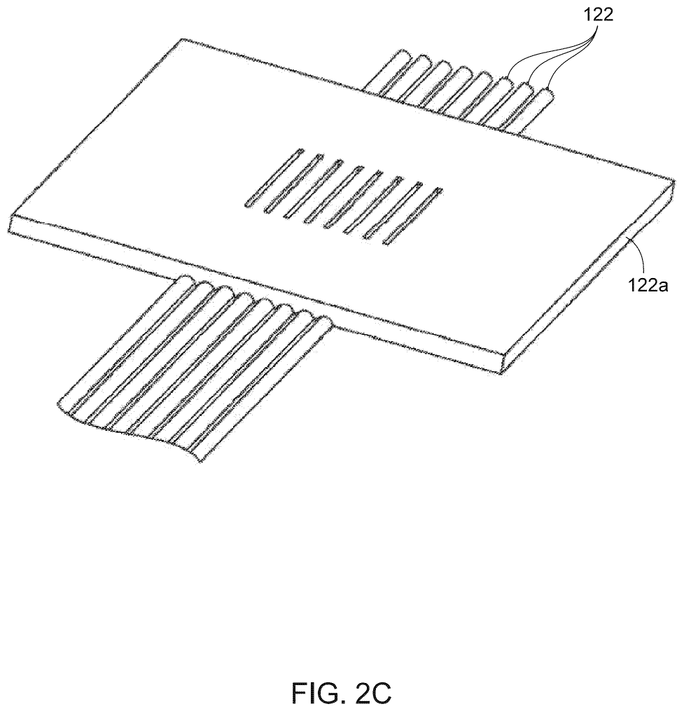

With particular reference to FIGS. 1A, 1C as well as FIG. 2A, the light generated by the light sources 102, 104, and/or 106 is received by an optical element (in this embodiment, a rotatable mirror 111, which is mounted on a galvanometer 111a and which is also herein referred to as a galvanometric mirror). The optical element directs the light (e.g., the light generated by the sources 102, 104, and/or 106) to at least one capillary (e.g., a plurality of capillaries 113 that are mounted in a cartridge 114) along at least one common path. The cartridge can be placed within a slot between a plate (122) and a lens (112) such that at least a portion of each of the plurality of capillaries can be placed in the common path. With particular reference to FIGS. 1A, 1C as well as FIG. 2A, a lens 112 (e.g., a focusing lens) is positioned between the light sources and the at least one capillary. The lens can focus the light into at least one capillary (e.g., a plurality of capillaries 113 that are mounted in a cartridge 114). Thus, with particular reference to FIGS. 1A, 1C as well as FIG. 2A, the optical element (e.g., a rotatable mirror 111, which is mounted on a galvanometer 111a) directs the light from the light sources to a lens 112 (e.g., a focusing lens) that can focus the light into at least one capillary (e.g., a plurality of capillaries 113 that are mounted in a cartridge 114).

In some embodiments, each of the capillaries is configured to receive a sample. In some embodiments, a plurality of capillaries might be used. For example, the plurality of capillaries 113 mounted in a cartridge 114 may be used. With specific reference to FIGS. 2B and 2C, the plurality of capillaries 113 may be bonded to a chip 113a; windows 113b might be provided through which a light (e.g., a UV light or a visible light) can pass to interact with a sample in the capillaries (e.g., a sample flowing through the capillaries). In various embodiments, the windows control the passage of the light through the capillaries so as to yield an optimal performance of the system.

In some embodiments, the cartridge is insertable (slidably or otherwise) into and removable from the system as described herein. In some embodiments, the cartridge is mounted to the system when in an inserted state. When the cartridge is in an inserted state, the capillaries 113 contained within the cartridge 114 are positioned to receive the light generated by any of the light sources (e.g., a first and/or the second light source). While various embodiments have been illustrated and described in detail in the drawings and description, other variations of the disclosed embodiments can be understood and effected by those skilled in the art in practicing embodiments of the present disclosure, from a study of the drawings, the disclosure, and the appended claims. For example, other embodiments where a system does not necessarily include a capillary (e.g., where a capillary or a cartridge comprising capillary can be removed from the system) can be envisioned. For example, in some embodiments, a system may comprise a first light source for generating a first light (e.g., configured to be at least partially absorbed by the sample (e.g., a UV light)), a second light source for generating a second light (e.g., configured to excite fluorescence of the sample (e.g., a visible light or another UV light)), an optical element for receiving and directing the first and the second light into at least one position in a slot. In some embodiments, at least one capillary or a cartridge comprising at least one capillary can be inserted into the slot. In some embodiments, once the at least one capillary is inserted into the system, at least a portion of the capillary occupies the at least one position in the slot. For example, once inserted into the system, a window of the at least one capillary (e.g., such as windows 113b of FIG. 2B) occupy the at least one position. In some embodiments, the system may further comprise a detector (e.g., an absorbance detector (e.g., a UV absorbance detector)). In some embodiments, the system also comprises a shutter positioned between the at least one position in the slot or the slot and the detector. In some embodiments, the shutter is movable between the undeployed and the deployed positions. In some embodiments, in the undeployed position, at least the portion of the first light passing through said at least one position in the slot (or the slot) can be received by the detector (e.g., absorbance detector). In some embodiments, in the deployed position, the shutter can reflect and/or absorb the light exiting said at least one position in the slot (or the slot) so as to inhibit back reflection thereof to said at least one position (or the slot). In some embodiments, as noted above, the shutter can at least partially reflect and/or at least partially absorb the light exiting the at least one capillary so as to inhibit (at least partially) the back reflection of the light exiting the at least one capillary back to that capillary and/or one or more adjacent capillaries. For example, the shutter can reflect the light exiting the at least one capillary in a direction (e.g., away from the at least one capillary) that is different from a direction associated with a back reflection of the light to the at least one capillary.

With particular reference to FIGS. 1A and 1C, in use, the galvanometer 111a can be operated under the control of a controller (not visible in these figures) to step the rotatable mirror through a plurality of positions so as to scan the light incident on the rotatable mirror 111 across the plurality of the capillaries. At each position of the rotatable mirror 111, the light generated by each of the light sources 102, 104, and 106 propagates along a common path (e.g., a path CP shown schematically in FIG. 1C), via the focusing lens 112, into one of the capillaries.

The light exiting each capillary may be received by a detector 116 (e.g., an absorbance detector (e.g., a UV absorbance detector)) having a UV lens 116a. Further, at least for the UV light, the UV lens 116a (See, e.g., FIG. 1D) can focus the light onto the light-detecting elements of the detector. Further, in some embodiments, although the detector 116 (e.g., the UV absorbance detector) is primarily used for detection of UV light, in various embodiments, it is also capable of generating detection signals in response to other light that is incident thereon (e.g., a visible light or laser light). By way of example, and without limitation, the UV detector can be a photodiode detector.

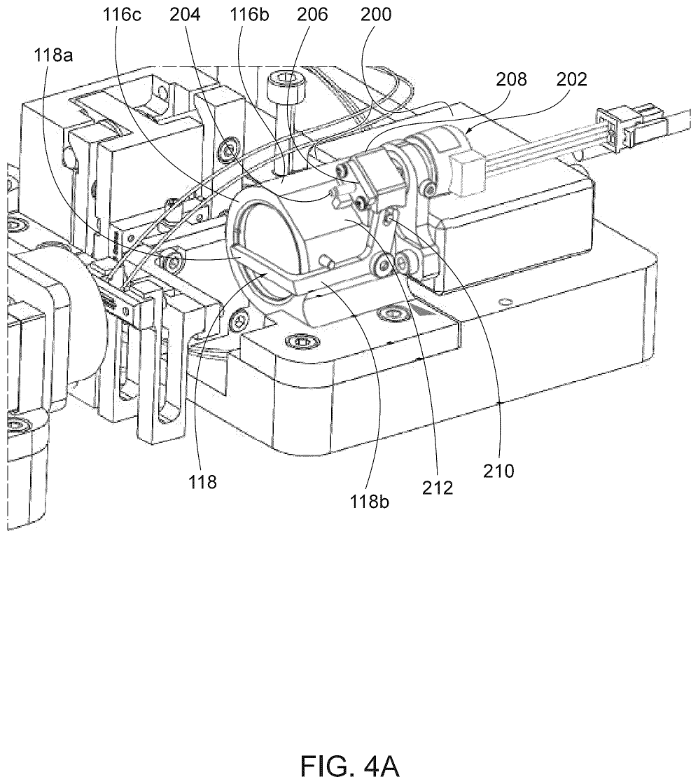

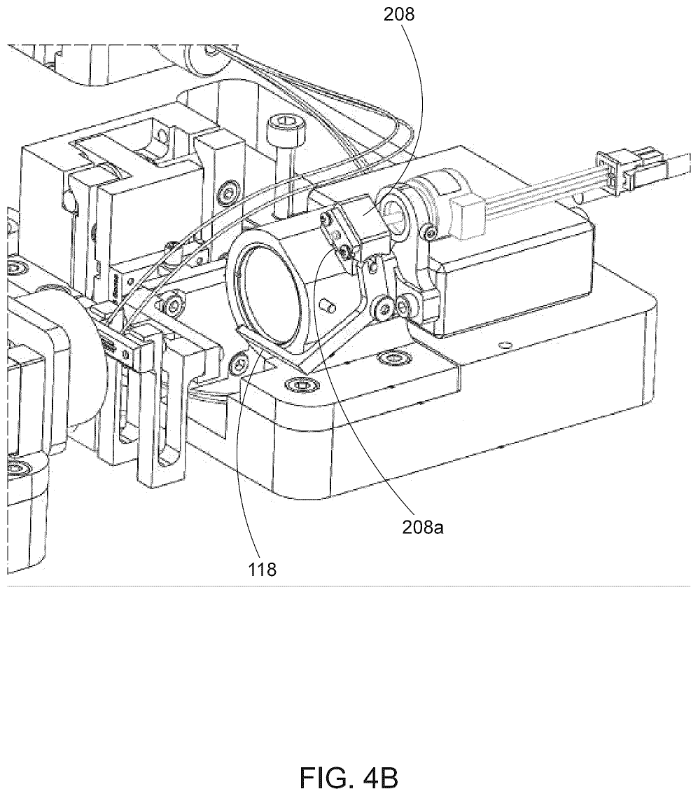

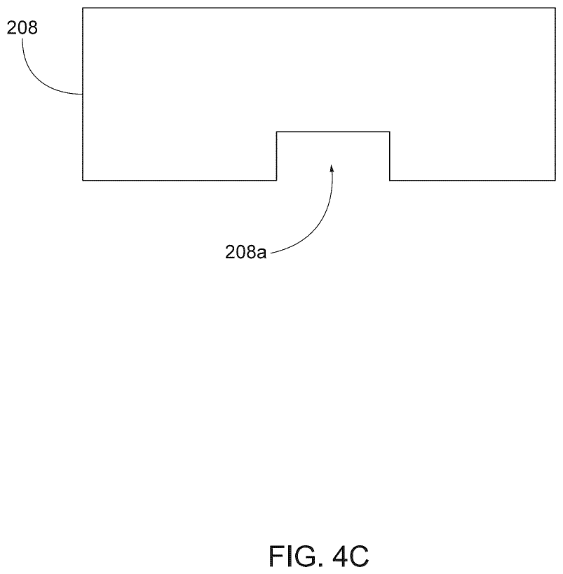

As discussed in more detail below, with specific reference to FIGS. 1A, 1D, 4A, and 4B, the system 100 includes a shutter 118 that is positioned between at least one capillary (e.g., the plurality of capillaries 113) and the detector 116 (e.g., an absorbance detector). The shutter 118 can move under the control of a controller (not visible in this figure) between an undeployed position and a deployed position. In a deployed position (See, e.g., FIG. 4A), the shutter reflects and/or absorbs a light exiting the at least one capillary so as to inhibit back reflection thereof to the at least one capillary. In some embodiments, in a deployed position, the shutter at least partially blocks a light exiting the capillaries from reaching the detector. With specific reference to FIG. 4A, the shutter 118 is positioned between the capillaries and the detector (e.g., an absorbance detector); in this embodiment, it is positioned in front of the detector's lens (e.g., a UV lens) 116a (see FIG. 1D). In an undeployed position (see, e.g., FIG. 4B), at least a portion of the light (e.g., the first light (e.g., a first UV light)) passing through the capillaries can be received by the detector (e.g., an absorbance detector (e.g., UV absorbance detector)). With specific reference to FIG. 4B, the shutter does not block the detector and hence the light propagating toward the detector is not at least partially blocked from entering the UV detector. In some embodiments, the shutter is sufficiently wide to block the light (or a portion thereof) exiting the capillaries that would otherwise reflect back to the capillaries. In some embodiments, the shutter can fully block the light exiting the capillaries from reflecting back to the capillaries. In some embodiments, the shutter can partially block the light exiting the capillaries from reflecting back to the capillaries. In some embodiments, when the shutter is in a deployed position, it can fully block the second light (e.g., a visible light (e.g., a laser light)) from entering the detector (e.g., an absorbance detector (e.g., UV absorbance detector)).

In some embodiments, during a setup period, the first light source is activated to generate the first light or the second light source is activated to generate the second light. In some embodiments, during a setup period, the light source 106 is activated (to generate, e.g., a first UV light). In some embodiments, when the light source 106 is activated, one of the filters 108a/108b can be employed to select a wavelength of interest (e.g., wavelengths of 214 nm, 220 nm, 260 nm, and 280 nm). In some embodiments, the light source 102 is activated to generate, e.g., a visible light (e.g., a laser light)). In some embodiments, the light source 104 is activated to generate, e.g., a second UV light.

In some embodiments, the mirror 111 receiving a light (e.g., a first light (e.g., a first UV light) or a second light (e.g., a second UV or a visible light)) is rotated so as to sweep the light across at least one capillary (e.g., the array of capillaries 113). In some embodiments, the position of the at least one capillary (e.g., a position of a center of at least one capillary) is identified via the detection by a detector (e.g., an absorbance detector (e.g., a UV absorbance detector)). In some embodiments, a detector 116 may be used. In some embodiments, as discussed above, a capillary can include a window that allows the passage of the light into the capillary. In some embodiments, the light (e.g., a first light (e.g., a first UV light) or a second light (e.g., a second UV or a visible light)) passes through the window associated with the capillary (e.g., during the sweep of the light across the capillaries); the detector may generate a signal associated with the sweep, where the signal exhibits a number of peaks corresponding to the passage of the light through the windows of the capillaries. In some embodiments, the midway point between the start and the end of each peak may correspond to the center of the capillary window and thus that of the capillary.

In some embodiments, once the position of the at least one capillary is identified, the system 100 can be operated in any one of its modes—e.g., any of the three modes, namely, (1) the UV absorbance mode, (2) the native fluorescence mode, or (3) the LIF mode. In some embodiments, the step of identifying the at least one capillary is performed for each operating mode as the different positions of the light sources (e.g., the first light source or the second light source) can result in different propagation directions of the respective light, thus necessitating a separate determination of the position of the at least one capillary for each mode.

In some embodiments, when the system 100 is operated in the UV absorbance mode, the shutter is in the undeployed position, so at least a portion of the first UV light passing through the at least one capillary can be received by the absorbance detector. In some embodiments, the shutter is in the undeployed position so as to allow the detection of at least a portion of the first UV light passing through the capillaries, thereby allowing the determination of the absorbance of the first UV light by the samples in the capillaries (e.g., flowing through the capillaries).

In some embodiments, a first light source comprises a first UV light source. In some embodiments, the first UV light source comprises a broadband UV light source. For example, a first UV light source 106 may provide a UV light (e.g., the first UV light) with a broad spectrum for performing UV absorbance measurements. In some embodiments, the broadband UV light source comprises a UV lamp. As discussed above, one of the two filters 108a/108b can be selected for filtering the UV light generated by the light source 106 (which, e.g., may include a UV lamp) so as to obtain a desired wavelength of the UV light for interacting with the sample(s) in the capillaries. In some embodiments, the UV light (e.g., the UV light for interacting with the sample(s) with the desired wavelength) propagates to the rotatable mirror 111, which can be rotated to scan at least one capillary. For example, the UV light can be scanned across the capillaries 113 such that the UV light passes through each capillary to interact with samples in each capillary (e.g., samples flowing through each capillary). In various embodiments, the focusing lens 112 can focus the UV light at the center of each capillary and the galvanometric mirror 111 can be used for scanning to illuminate the samples in the capillaries one at a time, e.g., in an interlacing pattern or in a serial pattern.

In some embodiments, in the UV absorbance mode, the shutter 118 is in an undeployed position such that at least a portion of the UV light passing through the capillaries is received by the detector 116 (e.g., a UV absorbance detector). In some embodiments, the detector generates light detection signals in response to the detection of the UV light. In some embodiments, the light detection signals generated by the detector (e.g., a UV absorbance detector) can be processed in a manner known in the art to determine the UV absorbance of the samples in the capillaries. More specifically, a reduction in the intensity of the UV light after its passage through a sample (or a portion of it) in any of the capillaries can be correlated to the absorbance of the UV light by that sample.

In some embodiments, in the native fluorescence mode, a UV light source 104 (e.g., a second light source for generating a second UV light) is activated to generate a UV light. In some embodiments, the second light source comprises a second UV light source. In some embodiments, the second UV light source comprises a monochromatic (or near monochromatic) UV light source. In some embodiments, the monochromatic (or near monochromatic) UV light source comprises a UV light emitting diode (LED). For example, the UV light source 104 can include an LED that is activated to generate monochromatic (or near monochromatic) UV light. In some embodiments, a UV light source may include a collimator that may be employed to collimate the UV light generated by the UV light source (e.g., the collimator with a fixed optical filter). Then, for example, the filter mount 110 is rotated (e.g., by 90 degrees) to allow passage of the UV light (e.g., the UV light generated by the UV LED) to the rotatable mirror 111, which in turn directs the received light onto the focusing lens 112. In some embodiments, the rotatable mirror can be adjusted (rotated) to receive the UV light (e.g., monochromatic or near monochromatic) and can then angularly scan to transmit the UV light across the plurality of the capillaries. In some embodiments, the UV light can cause the excitation of one or more native fluorophores of one or more of the samples in the capillaries, which can in turn emit native fluorescent light.

With particular reference to FIGS. 1A and 1C, in this embodiment, the system 100 further includes a fluorescence detector 180 (for detecting, e.g., the laser-induced or native fluorescence). In this embodiment, the fluorescence detector is a photomultiplier tube (PMT) that can detect the fluorescent light emitted by the samples in the capillaries in response to excitation thereof via a visible light (e.g., a laser light) or a second UV light (e.g., a monochromatic or near monochromatic light).

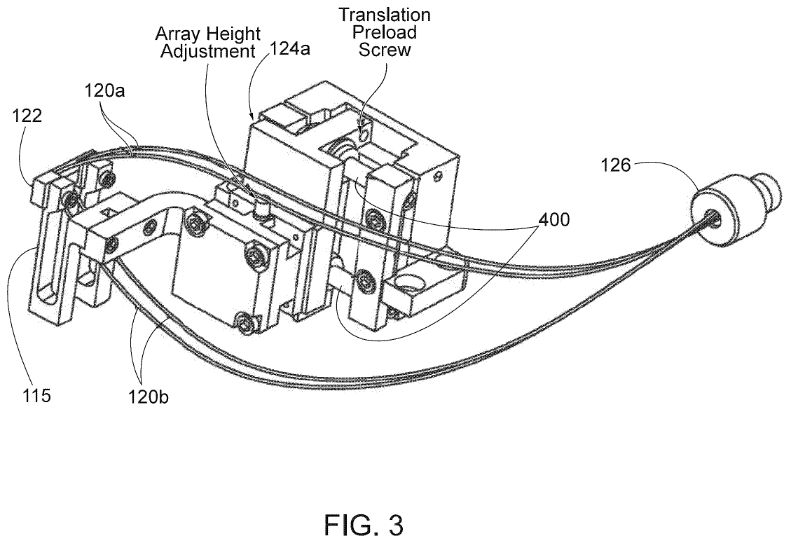

More specifically, an array of optical fibers 120a (see also FIG. 3) is positioned above the plane of the optical axis of the excitation light with the fibers angled downward at about 45 degrees so as to receive at least a portion of the fluorescent light emitted by the sample(s) in the capillaries (e.g., flowing through the capillaries). Another array of optical fibers 120b is positioned below the plane associated with the propagation of the excitation light with the fibers angled upward at about 45 degrees to receive at least a portion of the fluorescent light emitted by the sample(s) in the capillaries. In general, the upper and the lower optical fibers are angled such that their putative extensions would intersect at the core of the capillaries where the light passes through. As shown in FIG. 3, in some embodiments, a plate (122) supports the proximal ends of the optical fibers, a spring (115) (e.g., a non-conductive spring) receives a cartridge containing the capillaries, and a translation stage (124a) moves the mount and the plate. The number of optical fibers is not limited to that depicted in this example. By way of example, the number of any of the upper and the lower optical fibers can be in a range of about 2 to about 20, though other numbers of optical fibers can also be employed. In this embodiment, the proximal ends of the optical fibers are attached to a plate 122 that is in turn attached to the spring 115 onto which the cartridge 114 containing the capillaries can be mounted, as discussed above. With reference to FIGS. 1A and 3, the spring 115 can be coupled to a translational stage 124a, which allows adjusting the height of the mount so as to align the capillaries with the UV or the laser light. A plurality of guide rods 400 can bring the light-collecting fibers into proximity of the capillaries. With reference to FIGS. 1A and 3, the distal ends of the optical fibers 120a/120b are coupled to a fiber coupler 126 that aligns the distal ends of the optical fibers with the fluorescence detector 180 for efficient coupling of the fluorescent light (e.g., for laser-induced or native fluorescence detection) into the fluorescence detector.

In some embodiments, unlike in the absorbance mode (e.g., UV absorbance mode), when the system 100 operates in the fluorescence mode (e.g., native fluorescence mode or LIF mode), the shutter 118 is transitioned into the deployed position. In some embodiments, in the deployed position, the shutter reflects and/or absorbs a light exiting the at least one capillary so as to inhibit back reflection thereof to the at least one capillary (which, e.g., would otherwise cause crosstalk for the fluorescence signals generated by the sample(s) in the capillaries). In some embodiments, the at least one capillary comprises a first capillary and at least one other capillary, and wherein in the deployed position, the shutter reflects and/or absorbs a light exiting the first capillary so as to inhibit back reflection thereof to the at least one other capillary. In some embodiments, in the absence of the shutter being deployed, the light exiting the first capillary, when reflected back, would have interfered with the proper analysis and/or detection of the fluorescence from the at least one other capillary (e.g., caused a signal from the first capillary to be observed and/or interfere with the data collected for the at least one other capillary). In some embodiments, in the absence of the shutter being deployed, the back reflection (e.g., of the light exiting the capillary into the same capillary or other capillaries) can cause an increase in the noise level in the detected fluorescent signal. In some embodiments, the shutter at least partially blocks the light exiting the capillaries from entering the detector.

By way of further illustration, with reference to FIG. 1F, in various embodiments, the shutter 118 can have a slanted (e.g., in a downward direction) surface 118c relative to the propagation direction of a light (e.g., a light exiting at least one capillary) so as to reflect the light into a direction different from the propagation direction (in some embodiments, a portion of the light incident on the surface 118c may be absorbed). By way of example, a putative normal axis (NA) to the slanted surface can form an angle (a) relative to the propagation direction of the light. By way of example, and without limitation, the angle (a) is such that it would inhibit back reflection of the light incident thereon to the at least one capillary (e.g., the angle is such that the shutter would reflect the light away from the capillaries). In some embodiments, the slanted surface may have light reflecting and/or light absorbing properties.

With reference to FIGS. 1A, 1D and 1E, in some embodiments, when the system 100 is operated in the LIF mode, the laser source 102 is activated and the rotatable mirror 111 is rotated to receive the laser light (e.g., a visible light) generated by the laser source 102 and direct the laser light to the at least one capillary. In some embodiments, the light exiting the at least one capillary will be directed towards the lens 116a. In some embodiments, the laser source generates laser light with a wavelength in the visible range of the electromagnetic spectrum, which can excite one or more fluorophores in the sample(s) in the capillaries. By way of example, in some cases, the fluorophores can be one or more of fluorescent labels attached to molecules within the sample(s), e.g., fluorescent tags attached to compounds (e.g., proteins, antibodies, etc.) within the sample(s). In some embodiments, similar to the native fluorescence (generated, e.g., via UV excitation), the fluorescence generated via excitation of the samples by the laser light can be collected by the two bundles of optical fibers 120a/120b to be transmitted to the fluorescent detector 180. The signals generated by the fluorescence detector can be processed (analyzed) in a manner known in the art to obtain information about the sample(s) under study.

In some embodiments, during the LIF mode, the shutter 118 is in a deployed position to inhibit the reflection of the light exiting the at least one capillary, e.g., via the lens of the UV detector, back to the capillaries. In particular, in some embodiments, the shutter surface is slanted relative to the propagation axis of the light exiting the capillaries so that the light reflected by the shutter's surface propagates in a direction other than the propagation direction of the incoming light, thereby inhibiting the return of the light reflected at the surface of the shutter to the capillaries. This can in turn advantageously reduce, and preferably eliminate, crosstalk among different capillaries and/or reduce noise.

In other words, in some embodiments, in the absence of the shutter (e.g., shutter blocking the UV detector's lens) during the LIF measurement, a portion of the light (e.g., light exiting capillaries, excitation light) can be reflected from the UV detector's lens to reach the capillaries. The back reflecting light can enter one or more capillaries (e.g., capillaries other than the target capillary), thereby causing spurious fluorescent light emission from those capillaries, which can interfere with the analysis of the fluorescent light emitted from the target capillary. Further, in some embodiments, in absence of the shutter blocking the lens, a portion of the laser light incident on the lens can also be scattered, rather than being specularly reflected. In some embodiments, although some of the scattered light may find its way to capillaries other than the target capillary, the scattered light poses less of a problem than the specularly reflected light.

With reference to FIGS. 4A and 4B, in this embodiment, the shutter 118 includes a light-blocking arm 118a and a lever arm 118b that is connected to the light-blocking arm. While in this embodiment, the light-blocking arm and the lever arm form an integral unit, in other embodiments they can be formed as separate units and subsequently connected to one another. The lever arm is in turn operably coupled to an actuating system 200 that can cause the up-and-down motion of the shutter to transition the shutter between the deployed and the undeployed positions.

With reference to FIGS. 4A and 4B, the system further includes an actuating system 200. In this embodiment, the actuating system includes a stepper motor 202 having a rotatable screw shaft 204 with an associated nut 206 that is coupled to a mount 208 via a plurality of fasteners (e.g., screws). The mount includes a central opening (not visible in this figure) through which the screw shaft extends. A lower surface of the mount 208 includes a slot 208a (see, FIG. 4C) that is sized and shaped for receiving a block 210 that protrudes above a surface 212 of the UV detector's housing 116b and is fixedly attached to that surface. A pin 210 is pressed into the mount (208) that holds the nut (206); the pin slides the shutter's lever arm 118b. In use, upon activation of the stepper motor 202, the rotation of the screw shaft 204 results in translation of the mount 208 along the shaft over the protruding block 210, which in turn causes the up-and-down motion of the shutter 118. For example, for one sense of rotation of the screw shaft (e.g., a clockwise rotation), the mount 208 moves away from the stepper motor to lower the shutter, thereby allowing the light exiting the capillaries to reach the UV detector, as shown schematically in FIG. 4B. For the rotation of the screw shaft in an opposite sense (e.g., a counter-clockwise sense), the mount moves closer to the stepper motor, thereby raising the shutter such that the light-blocking arm of the shutter at least partially blocks the entry of the light exiting the capillaries into the UV detector, as shown schematically in FIG. 4A.

The shutter, including its light-blocking arm and its lever arm, can be formed of a variety of suitable materials. Some examples of such materials include, without limitation, polymer—(e.g., plastic), ceramic-, resin-, and/or metal-based materials (or combinations thereof), with or without coating(s). In some embodiments, the width of the shutter's light-blocking arm is at least as large as the diameter of the light beam incident on the shutter's surface. In general, the shutter's light-blocking arm can have a variety of different widths. By way of example, and without limitation, in some cases, the width of the shutter's light-blocking arm can be at least 10%, or at least 20%, or at least 30%, or at least 40% larger than the diameter of the light beam on the shutter's surface.

The operation of the stepper motor can be controlled by a controller (e.g., such as described further below). In some embodiments, the shutter is in the deployed position when the second light source is generating the second light and/or when the second light is employed for performing a native fluorescence measurement or a laser-induced fluorescence (LIF) measurement. In some embodiments, the stepper motor can be controlled by the controller such that when the second light source is generating the second light and/or when the second light is employed for performing a native fluorescence measurement or a laser-induced fluorescence (LIF) measurement, the shutter is in a deployed position. In some embodiments, the stepper motor can be controlled by the controller such that when a laser source is generating a laser light, or during the LIF or native fluorescence measurements, the shutter is in a deployed position. In some embodiments, in an undeployed position, at least a portion of the first light passing through the at least one capillary can be received by the absorbance detector. In some embodiments, during the UV absorbance measurements, the stepper motor is activated to position the shutter in an undeployed position (e.g., to allow the detection of the UV light exiting the capillaries via the UV detector).

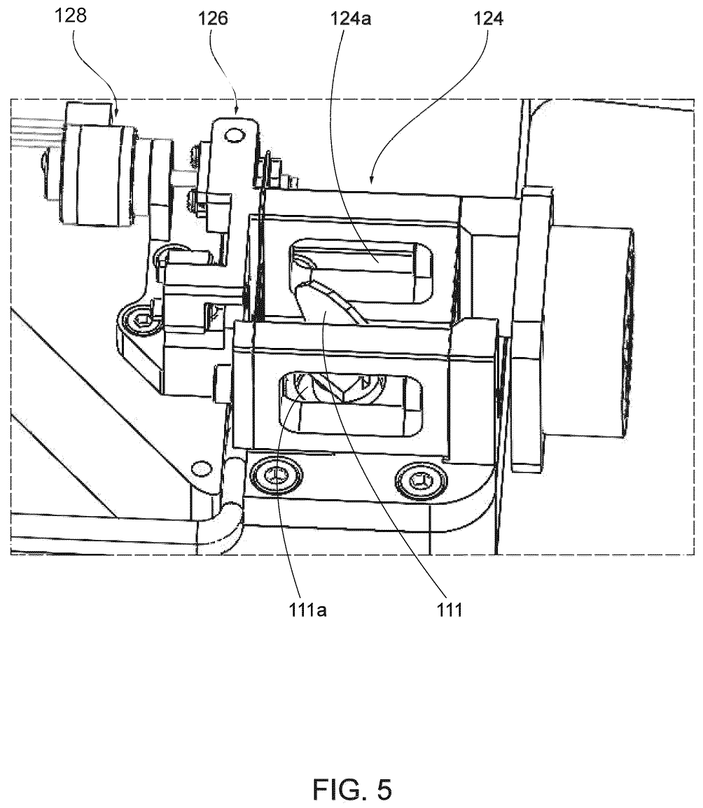

In various embodiments, the system may include or methods might use a focusing lens positioned between at least a first light source (e.g., a first UV light source) or a second light source (e.g., a second UV light source or a visible light source (e.g., a visible laser light source)) and at least one capillary. In some embodiments, such a lens may be used for focusing the first light (e.g., a first UV light) or the second light (e.g., a second UV light or a visible light (e.g., a visible laser light)) into the at least one capillary. In some embodiments, the focusing lens is movable to accommodate a change in a focal length thereof based on a change in wavelength of the first and/or the second light. In some embodiments, the transition of the system from one mode to another may necessitate an adjustment of the distance (e.g., axial distance) between the focusing lens and the at least one capillary. For example, with reference to FIGS. 1C and 2A, the distance between the focusing lens 112 and the capillaries 113 might need to be adjusted, as, e.g., the focal length of the lens may be a function of the wavelength of the first or the second light. For example, in various embodiments, transitioning the system from the absorbance mode (e.g., UV absorbance mode) to the fluorescence mode (e.g., native fluorescence mode (e.g., using a second UV light) or LIF mode) is accompanied by a shift in the axial position of the focusing lens. By way of example, in some embodiments, the light wavelength for performing a UV absorption measurement can be 220 nm while the wavelength of light for performing native fluorescence measurement can be, e.g., longer (e.g., 280 nm, 295 nm). In some embodiments, in such a case, to accommodate a change in the focal length of the focusing lens, a mechanism for moving the focusing lens is provided (see, e.g., FIG. 5). With specific reference to FIG. 5, the mechanism includes a movable mount 124 to which the focusing lens in mounted, where the mount includes an opening 124a through which the light from any of the light sources can pass to reach the rotatable mirror 111. A translation stage 126 mechanically coupled to the movable mount 124 can be moved back-and-forth via a motor 128 so as to change the axial distance of the focusing lens 112 relative to the capillaries 113.

In various embodiments (e.g., those discussed above), one or more controllers are employed for controlling the operation of the system (e.g., electrophoresis system), such as the transition of the shutter between the deployed and the undeployed positions, the activation and deactivation of the light sources (e.g., the first and the second light sources), scanning across at least one capillary using an optical element, the rotation of the rotatable mirror to scan the light across the capillaries, the adjustment of the position (e.g., axial) of the focusing lens, and/or the analysis of the signals (e.g., fluorescence or absorbance signals) generated by detector(s) (e.g., fluorescence or absorbance detector) of the system.

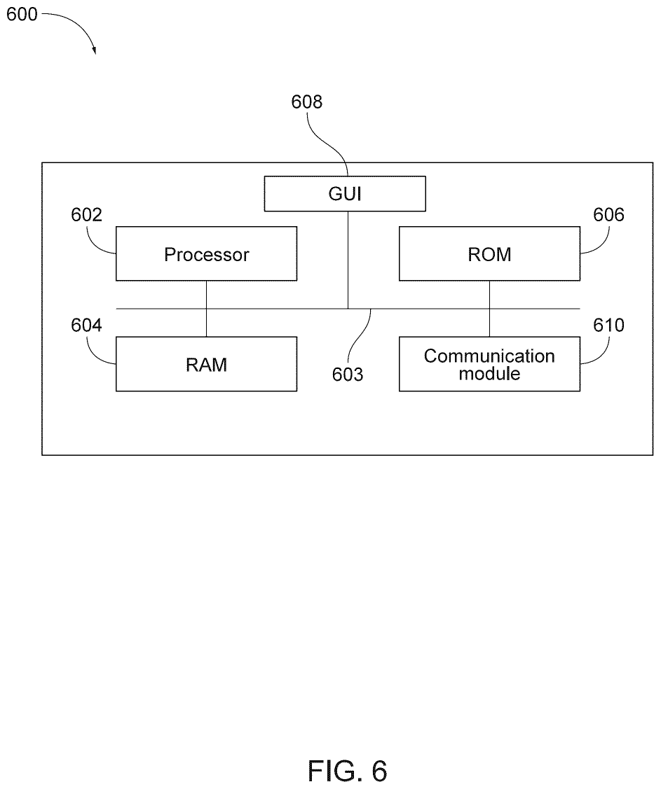

By way of example, FIG. 6 schematically depicts an example of an implementation of a controller 600 that can be used in the practice of various embodiments of the present teachings. The controller 600 includes a processor 602, a random access memory (RAM) module 604, a permanent memory module 606, a user interface (e.g., graphical user interface) 608 and a communications module 610, which allows the controller to communicate with other devices/components in the system (e.g., electrophoresis system), such as, for example, the stepper motor of the mechanism configured for transitioning the shutter between the deployed and the undeployed positions, the light sources, the galvanometer for rotating the rotatable mirror, the mechanism for positioning the focusing lens, etc. A communications bus 603 allows various components of the controller 600 to communicate with one another. In other implementations, various functionalities for operating different devices/components of the electrophoresis system can be distributed among a plurality of separate controllers.

Instructions for operating various devices/components of the electrophoresis system can be stored in the permanent memory and can be transferred via the processor 602 to the RAM module during runtime for execution. For example, the instructions can specify that during a setup period (e.g., upon the initial activation of the electrophoresis system), a setup procedure for identifying the positions of the capillaries should be executed. In some embodiments, the setup procedure can be based on previously-loaded instructions that result in sending control signals to the first or second light source for activating one of those light sources. In some embodiments, the instructions can also result in generation of control signals for causing the rotatable mirror to scan the first or the second light across the capillaries. Further, in some embodiments, the stored instructions can cause transmission of control signal(s) to the mechanism for moving the shutter to position the shutter in an undeployed position while the setup procedure is performed. As discussed above, during the setup procedure, the light exiting the capillaries is detected (e.g., by a detector, which generates light detection signals in response to the detection of the light). In some embodiments, the controller 600 can receive the light detection signals. In some embodiments, an algorithm for processing the light detection signals to identify the positions of the capillaries is stored on the controller, which can be executed to analyze the light detection signals for identifying the positions of the capillaries, e.g., the positions of the light-transmissive windows of the capillaries, relative to the propagation direction of the light.

In some embodiments, subsequently, the instructions stored on the controller can cause the initiation of one of the operational modes of the electrophoresis system. For example, following the setup procedure, the controller can initiate the absorbance mode (e.g., a UV absorbance mode) via generating and sending a control signal to the first light source (e.g., a first UV light source) to generate a first light (e.g., a first UV light) for illuminating the samples in the capillaries (e.g., flowing through the capillaries). In some embodiments, the controller can further send a control signal to the galvanometer to cause the rotation of the rotatable mirror so as to scan the first light (e.g., the first UV light) across the capillaries. In some embodiments, at least a portion of the first light (e.g., at least a portion of the first UV light) passing through the capillaries can be detected by an absorbance detector (e.g., the UV absorbance detector); in some embodiments the absorbance detector generates UV absorbance detection signals. In some embodiments, instructions for analysis of the UV absorbance detection signals can also be stored on the controller. In some embodiments, alternatively, a separate controller (herein also referred to as analysis or processing module) can receive the UV absorbance detection signals during this operational mode and obtain UV absorbance of the samples.

In some embodiments, subsequently, the controller can deactivate the first light source (e.g., the first UV light source), send a control signal to the mechanism for moving the shutter to position the shutter in the deployed position and activate the second light source (e.g., a second UV light source or visible light source (e.g., a visible laser source)) to generate a second light for eliciting fluorescence from the samples. In some embodiments, the controller can also store instructions for analyzing the fluorescent detection signals generated by the fluorescence detector of the electrophoresis system, or alternatively, such instructions may be stored on a separate analysis unit.

### Example 1—Effect of Shutter Deployment on Crosstalk and Noise in Multi-Capillary System

A multi-capillary CE instrument with 8 capillaries (similar to the one described in FIGS. 1A-E, 2A, 3-5) was equipped with a shutter (e.g., as described in FIGS. 4A-B). A system, in an LIF mode, was used to measure signal to noise (S/N) ratio and crosstalk % with and without deploying the shutter. Average peak-to-peak noise level observed without the shutter deployment was 0.020 RFU while with shutter deployment—0.011 RFU; S/N without shutter deployment was 3022, while with shutter deployment—5075. Crosstalk % decreased from 2.3% (without shutter deployment) to 0.026% (with shutter).

Depending on certain implementation requirements, embodiments of the present teachings, the controller can be implemented in hardware, firmware and/or in software.

In some embodiments, the instructions for operating the optical system can be stored using a non-transitory storage medium such as a digital storage medium, for example a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Those having ordinary skill in the art will appreciate that various changes can be made to the above embodiments without departing from the scope of the present teachings.

What is claimed is:

1. A system, comprising:
at least one capillary configured for receiving a sample,
a first light source for generating a first light,
a second light source for generating a second light,
an optical element for receiving and directing the first and the second light into the at least one capillary,
an absorbance detector, and
a shutter positioned between the absorbance detector and the at least one capillary,
wherein the shutter is movable between an undeployed position and a deployed position,
wherein in the undeployed position, at least a portion of the first light passing through the at least one capillary can be received by the absorbance detector, and
wherein in the deployed position, the shutter inhibits back reflection of the light exiting the at least one capillary to the at least one capillary.

2. The system of claim 1, wherein the first light source comprises a first UV light source,
wherein, optionally, the second light source comprises a second UV light source or a visible light source, and
wherein, optionally, the second UV light source comprises any of a UV LED and a UV laser, and said visible light source comprises a visible laser light source.

3. The system of claim 1, wherein said first light source and said second light source comprise two different UV light sources.

4. The system of claim 3, wherein one of said two different UV light sources comprises a broadband UV light source and the other one of said two different UV light sources comprises a monochromatic UV light source, and
wherein, optionally, said broadband UV light source comprises a UV lamp and said monochromatic UV light source comprises a UV light emitting diode (LED) or a UV laser.

5. The system of claim 1, further comprising a fluorescence detector configured for detecting a fluorescence of the sample generated in response to excitation thereof by the second light,
wherein, optionally, the fluorescence detector comprises a laser-induced fluorescence (LIF) detector or a native fluorescence detector.

6. The system of claim 5, wherein the first light is configured to be at least partially absorbed by the sample so as to allow measurement of an absorbance of the sample using the absorbance detector and the second light is configured to excite fluorescence of the sample so as to allow measurement of fluorescence emitted by the sample by the fluorescence detector.

7. The system of claim 1, wherein the at least one capillary comprises a first capillary and at least one other capillary, and wherein in the deployed position, the shutter inhibits back reflection of a light exiting the first capillary to the at least one other capillary.

8. The system of claim 1, wherein said shutter comprises a slanted surface for reflecting at least a portion of the light exiting the at least one capillary into a path different from a path along which the light exiting the at least one capillary propagates to the absorbance detector.

9. The system of claim 1, wherein in the deployed position the shutter at least partially blocks the light exiting the at least one capillary from reaching the absorbance detector, and
wherein, optionally, the system further comprises an actuating system for transitioning the shutter between the deployed and the undeployed positions.

10. The system of claim 1, wherein the optical element is configured to direct the first light and the second light into the at least one capillary along at least one common path.

11. The system of claim 1, wherein said at least one capillary comprises a plurality of capillaries and said optical element is configured to scan the first light and/or second light across said plurality of capillaries.

12. The system of claim 1, wherein the absorbance detector comprises a UV lens and said shutter is positioned in front of the UV lens.

13. The system of claim 1, further comprising at least one controller in communication with the shutter, wherein the at least one controller is configured to transition the shutter from the undeployed position to the deployed position when the second light source is generating the second light and/or when the second light is employed for performing a native fluorescence measurement or a laser-induced fluorescence (LIF) measurement.

14. The system of claim 13, wherein said at least one controller is further configured to control operation of the first and the second light sources,
wherein, optionally, said at least one controller comprises a first controller for controlling said shutter and a second controller for controlling the operation of said first and second light sources,
wherein, optionally, the at least one controller is further configured, during a setup period, to activate the first light source to generate the first light or the second light source to generate the second light, to cause said optical element to scan the first light or the second light across said at least one capillary, and to cause the light exiting the at least one capillary to be detected so as to determine a position of the at least one capillary, and
wherein, optionally, the position of the at least one capillary is determined relative to a propagation direction of the first light or the second light.

15. The system of claim 14, wherein the at least one controller comprises said first controller, said second controller, a third controller for controlling the optical element for scanning the first light or the second light, and a fourth controller for processing the detected light exiting the at least one capillary,
wherein, optionally, said at least one controller causes the light exiting the at least one capillary to be detected with the absorbance detector so as to determine the position of the at least one capillary,
wherein, optionally, said at least one controller causes the shutter to be in the undeployed position during the setup period.

16. The system of claim 14, wherein said at least one capillary comprises the plurality of capillaries and the at least one controller is further configured to scan the first light or the second light across said plurality of capillaries in an interlacing pattern.

17. The system of claim 1, further comprising a focusing lens positioned between the first light source or the second light source and the at least one capillary for focusing any of the first light and/or the second light, into said at least one capillary,
wherein, optionally, said focusing lens is movable to accommodate a change in a focal length thereof based on a change in wavelength of the first light and/or the second light, and
wherein, optionally, the system further comprises a lens scanning mechanism coupled to said focusing lens and operating under control of the controller for moving the focusing lens.

18. A method, comprising:
introducing a first light or a second light into at least one capillary configured to receive a sample,
using an absorbance detector to detect at least a portion of a light exiting the capillary,
subsequently, moving a shutter positioned between the at least one capillary and the absorbance detector into a deployed position in which the shutter inhibits back reflection of the light exiting the at least one capillary to the at least one capillary, and
performing a fluorescence measurement while the shutter is in the deployed position.

19. The method of claim 18, wherein in the deployed position, the shutter at least partially blocks the light exiting the capillary from reaching the absorbance detector.

20. A method comprising:
transitioning a shutter, positioned between an absorbance detector and at least one capillary in a multi-mode capillary electrophoresis system, between an undeployed position and a deployed position,
wherein in the undeployed position the absorbance detector can receive at least a portion of the first light passing through said at least one capillary, and
wherein in the deployed position the shutter inhibits back reflection of the light
exiting the at least one capillary to the at least one capillary, thereby reducing at
least one of a cross talk and a light detection noise in the at least one capillary, wherein the multi-mode capillary electrophoresis system comprises a first light source for generating the first light, a second light source for generating a second light and an optical element for scanning the first light and/or the second light across the at least one capillary and the absorbance detector for receiving the at least the portion of said first light passing through said at least one capillary.
